(19) United States
(12) Patent Application Publication
(10) Pub. No.: US 2009/0157418 A1
(43) Pub. Date: Jun. 18, 2009

(54) Method And System For Obtaining Geographic Location Information

(75) Inventors: Troy Coleman, Bowling Green, KY (US); James M. Hargrove, Alpharetta, GA (US)

Correspondence Address: AT&T Legal Department - WK;Attn: Patent Docketing, Room 2A-207, One AT&T Way, Bedminster, NJ, 07921, US

(73) Assignee: AT&T DELAWARE INTELLECTUAL PROPERTY, INC., Willington, DE (US)

(21) Appl. No.: 12/138,695

(22) Filed: Jun. 13, 2008

Related U.S. Application Data
(63) Continuation-in-part of application No. 11/954,908, filed on Dec. 12, 2007.

(51) Int. Cl. G06Q 10/00; G01S 1/00

(52) U.S. Cl. 705/1; 342/357.06

(57) ABSTRACT

Location data corresponding to the geographic location of a particular event is obtained in response to information concerning the event and received at a computing device present at the geographic location. The geographic location information is used to produce a map or other visual display corresponding to the event and to the geographic location thus obtained. The geographic location information may be obtained from any appropriate source such as a GPS receiver or wireless system capable of providing geographic location information with accuracy acceptable to the particular application. The GPS receiver or other source of geographic location information may be incorporated into the computing device, or may comprise a separate element operationally interrelated so as to obtain the current geographic location information in response to entering the event information at the computing device.

### CROSS REFERENCE TO RELATED APPLICATION

This is a continuation-in-part of co-pending U.S. application Ser. No. 11/954,908, filed Dec. 12, 2007.

### BACKGROUND

This application relates in general to obtaining geographical information, and relates in particular to obtaining geographic location information relevant to events.

Many situations require assimilating amounts of data relating to events occurring, for example, over a particular time and/or within a particular region. By presenting the data in a form suited for review and analysis, one may better understand such events and seek to mitigate undesirable events. For example, telecommunications wires and cables are subject to damage even when located underground, requiring immediate repair and possibly reducing signal carrying capacity if no backup or redundant signal capacity is available. Telecommunications operators typically maintain detailed records of damage occurring to such external physical plant and examine that data in an effort to determine where damage-prevention efforts might best be directed.

One technique for examining and analyzing data relating to damage comprises mapping data points so as to depict the density of incidents relating to the damage occurring within a selected geographic region. This technique is described in co-pending U.S. patent application Ser. No. 11/954,908, which is incorporated herein by reference.

Computer programs are known that can generate maps or other visual displays corresponding to information entered into the program. That information, usually in the form of database or spreadsheet data, may include a substantial amount of information relevant to anyone seeking to analyze the events or other activity giving rise to that data, but the raw data is usually not presented in a manner one can relatively easily comprehend, particularly with regard to trends or frequency-of-occurrence information. Moreover, although the geographical locations of structures (e.g., wires, cables, switching centers, or the like) are generally fixed and thus readily determinable, events such as damage or repair typically take place at variable geographic locations, and data corresponding to those variable geographic locations must be collected and entered along with other information relevant to those occurrences. Such other relevant information may include, for example, the date and time a particular event occurred, a numeric or alphanumeric code corresponding to or identifying the nature of the event, the remedial effort taken to fix the event, the time and date of closing a trouble ticket or other information relating to the event, and other information as will be understood by those skilled in the relevant art.

Presenting, in mapped or other graphical form, the data relating to variables such as trouble or other such events may show trends that might be less evident from the data in tabular form. However, such graphical presentations require data in a form acceptable to graphic or mapping software. Although some of that variable information may be incremental to the event or otherwise obtained retrospectively without substantial effort, the geographic location information of a particular event or problem may not be known with accuracy until a technician or repair crew arrives at the scene and fixes the problem. The relevant geographic location, once determined, must be obtained and saved in a form suitable for producing a map or other appropriate visual representation. Such geographic location information, moreover, should preferably be in latitude/longitude format or in some other form known to define an unambiguous spatial geographic location of the event. In any case, collecting and recording such geographic location information, and then entering that information in a database or other form suitable for access by a mapping or other graphic display program together with other data relevant to events occurring within a geographical region, may be time-consuming or otherwise inhibit the frequent use of such graphic display systems.

### SUMMARY

According to exemplary embodiments, a method, system, and computer program product are provided for obtaining location information relating to at least one task performed at a geographic location within a predetermined geographic region. Information is received relating to performance of the task at a computing device at the geographic location. In response to the received information, location data corresponding to the geographic location of the computing device and thus corresponding to the geographic location of the task is obtained.

Other methods, systems, or computer program products according to embodiments will be or become apparent to one with skill in the art upon review of the following drawings and detailed description. It is intended that all such additional systems, methods, and computer program products be included within this description, be within the scope of the present invention, and be protected by the accompanying claims.

### BRIEF DESCRIPTION OF THE DRAWINGS

FIG. 1 is a block diagram illustrating a system according to disclosed embodiments.

FIG. 2 is a flow chart illustrating a method according to disclosed embodiments.

### DETAILED DESCRIPTION OF THE PREFERRED EMBODIMENT

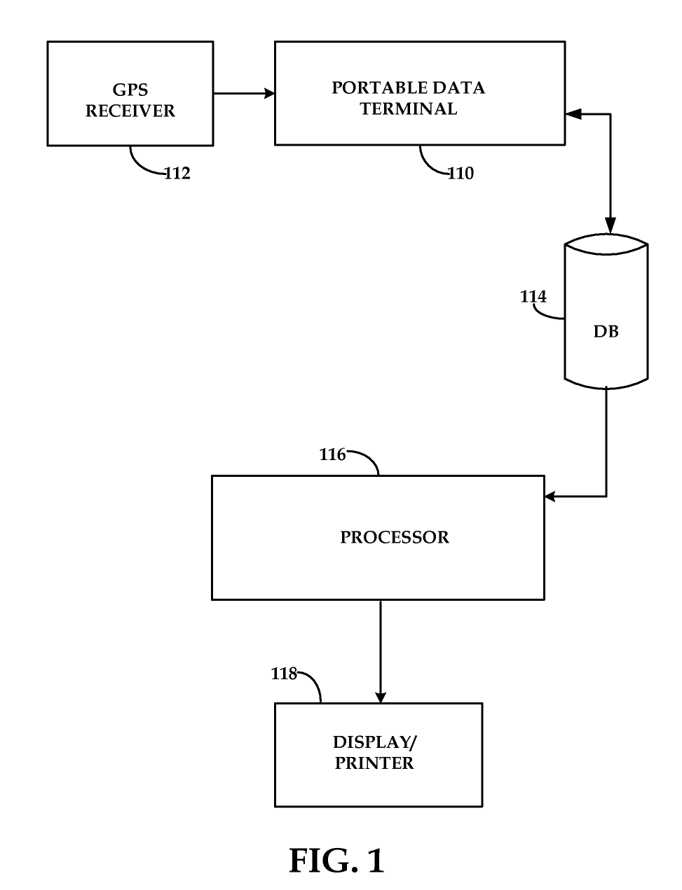

FIG. 1 shows a system according to an exemplary embodiment. Analyzing the occurrence of damage or other events occurring within a particular geographic region involves gathering data corresponding to the locations and natures of such events, occurring over a predetermined time interval of interest. The system depicted in FIG. 1 includes at least one portable data terminal 110 of a kind intended to be present at the geographic sites of repair, maintenance, or other events of interest within a particular geographic region. The portable data terminal 110, according to the disclosed embodiments, may be a conventional notebook computer or other computing device carried by service persons in the field or mounted within a service vehicle that will be present at job sites of interest. Alternatively, the portable data terminal 110 may comprise a purpose-designed terminal docked or installed within a service vehicle. The portable data terminal 110 may also comprise a handheld computing device such as a personal digital assistant (PDA) intended to be carried by a service person and optionally including communication capability, such as a cellular handset or other wireless device. Whatever form the portable data terminal 110 may take in a particular embodiment, those skilled in the art will understand that such data terminals for service applications may be provided with information of various kinds relating to the jobs at hand. That information, which may be manually entered into the computing device or downloaded from a database 114 which receives information from a central location concerned with dispatching a repair service, may include without limitation the time and date, the identity of a service vehicle and service personnel dispatched to a work site, and the nature of the problem or other event of interest.

The portable data terminal 110 receives geographic location data from, e.g., a GPS receiver 112 located in the vicinity of the task being performed. Where a service truck or other vehicle already has a GPS receiver onboard, the function of the GPS receiver 112 may advantageously be provided with a location signal feed supplied to the portable data terminal 110 from that existing GPS receiver. Otherwise, a separate GPS receiver 112 or other source of GPS-based or other geographical location data is provided, either incorporated into the portable data terminal 110 or as a separate unit operative to supply GPS location information on demand. Such GPS or other geographical location information, as is known to those skilled in the art, typically comprises longitude-latitude coordinate pairs based on the geographic location of the GPS receiver at a particular time, although the location information may alternatively be provided in an X-Y Cartesian format.

Although the use of GPS as a source of geographic location information is advantageous, other techniques for providing localization information of a portable data terminal may be employed. For example, wireless telecommunications networks may offer network-based solutions including TDOA (time difference of arrival), AOA (angle of arrival), TDOA/AOA in combination, and other network-based techniques. Systems and methods for implementing these techniques for a particular wireless carrier are within the skill of the ordinary artisan.

The geographic location information from the GPS receiver 112 may be supplied either on demand from the portable data terminal 112, or more or less continuously (e.g., at regular or periodic intervals) to the portable data terminal 110. That portable data terminal 110 may be programmed to log the current geographic location information from the GPS receiver 112 at least in response to entry into the portable data terminal of information indicating or corresponding to accomplishing a particular event at that geographic location. For example, upon completion of a task such as a service order or trouble ticket that resulted in dispatching a technician to a particular job site, the technician may enter information into the portable data terminal 110 at the time of completing the service, sometimes referred to as “closing the trouble ticket”. In response to that entry by the technician, the portable data terminal 110 may obtain or log signals corresponding to the current or latest geographic location information from the GPS receiver 112 and store that geographic location information.

The geographic location information obtained from the GPS receiver 112 by the portable data terminal 110 may be transferred to the database 114. That database 114, which may contain other information as mentioned hereinabove relating to the trouble ticket or other order for the task at hand, may be physically part of the portable data terminal 110, in which case information stored onto the database 114 may be downloaded or dumped from time to time into a database accessible by a processor 116 also having access to software for mapping or other visual display of information contained in the database. Alternatively, the portable data terminal 110 may be provided with a wireless communication link for relatively immediate transfer of information, including the geographic location information relating to completion of the job or other event, to the database 114 that is operationally associated with the processor 116.

The processor 116 receives information stored in the database 114 and operates, with appropriate programming, such as a geographic information system (GIS), to produce an output in a map or other graphical format of the data including the geographic information obtained from the GPS receiver 112 by the portable data terminal 110. That graphic-format information as produced by the processor 116 may be displayed or printed at the printer or display device 118. Because the geographic data is being entered into a geographic information system to visually convey information, e.g., in a map format, the location data obtained from the GPS receiver 112 is made available or converted into point data within the GIS for each location of interest. Examples of point data information are known to those skilled in the art, one example being longitude-latitude information as mentioned above.

One example of a geographic information system for performing embodiments of the present invention is the Arc Info system available from CSRI (Redlands, Calif.). However, it should be understood that the foregoing exemplary GIS program is disclosed without limitation and that embodiments of the present invention may use any suitable alternative GIS. It will also be understood that the processor 116 may be any personal computer or other computing device, for example, computers using either the Windows operating system or the Macintosh operating system, meeting the operating requirements of the GIS system being used.

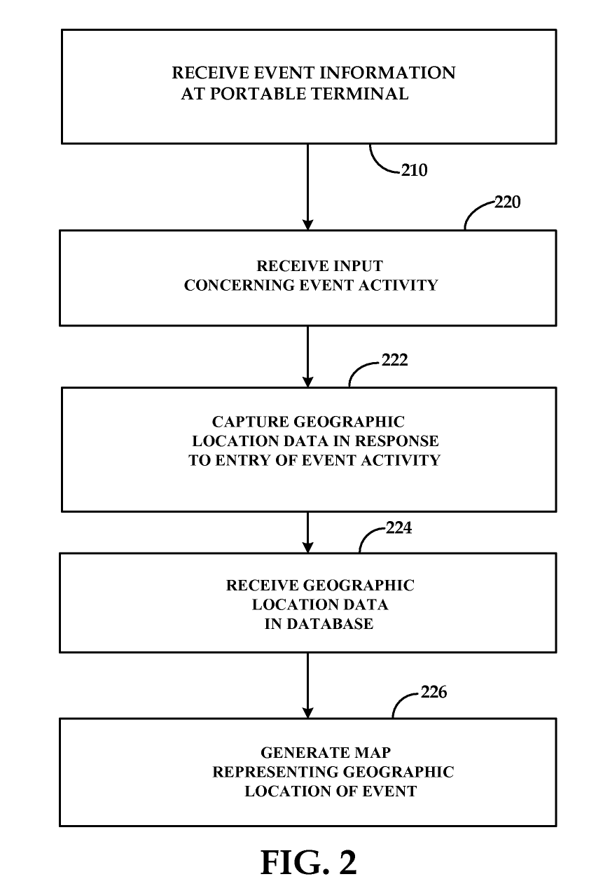

Operation of the disclosed embodiment is now discussed with respect to FIG. 2. As previously mentioned and as shown at step 210, information about the one or more events of interest is received at the portable terminal 110 as discussed above. Such data entry into the portable terminal may be accomplished, for example, by keyboard entry into the portable data terminal, or by transferring at least some of the information previously entered into or found in the database 114, as will be understood by those skilled in the art.

Analyzing damage or other operational events in a physical plant will call for gathering data about the physical plant, e.g., places where damage or other events have occurred within a particular geographic area and over a time interval of interest. (The term “physical plant”, as used herein, refers to the infrastructure that supports a particular facility or system.) The problems of mitigating or eliminating damage to physical plant are particularly compelling in fields such as telecommunications, although not so limited, because most of the physical plant is often located underground and is not visible to a casual inspection. For example, signal cables are often located underground and are subject to damage by activities such as trenching or horizontal boring to repair or install additional infrastructure. Because such damage may disrupt multiple signal paths, operators of outside physical plant seek to minimize damage to that plant by mapping and analyzing historical damage or other events occurring to the physical plant. Those analyses, to be most useful, should include accurate geographic-location information where damage occurred, and the information should be captured and made available for analysis so that managers can act on the information with minimum delay and without possible mistakes in manual entry of the information.

Information relating to the occurrence of a particular event of interest intended to trigger the capture of geographic location information is received at the portable data terminal 110 as at step 220 in FIG. 2. For example, if a technician is using the disclosed embodiment while servicing a trouble ticket, that technician would enter into the portable data terminal 110 information relating to that trouble ticket. That information might include, for example and without limitation, the nature and resolution of the problem, appropriate codes indicating the kind of problem and the nature of the communication calls or other infrastructure in which the problem occurred, the current time and date, and so on. In response to receiving such information concerning an event activity, such as fixing the problem or closing the trouble ticket, the portable data terminal 110 captures, at step 222, the geographic location information available from, e.g., the GPS receiver 112 and corresponding to the location of the GPS receiver at the time of entering the event-related information. That geographic location information may be received by the database 114 as previously mentioned and as shown by step 224. That location information becomes available for use by the processor 112 and the geographic information system operating thereon to generate a map or other visual display representing the geographic location of the event, at step 226.

It should now be understood that the geographic location information corresponding to each event of interest, such as damage repair events, may be automatically obtained by the portable data terminal 110 in response to a predetermined input concerning event activity received at that portable data terminal. After the location data for each instance of damage or other events of interest are obtained and entered as data points in the database 114, those data points may be transformed by the GIS and the processor 116 to produce a mapped density surface using the density analysis capability of the GIS. A visual display may thus be prepared at 118, e.g., preferably in the form of a map displaying the density surface of the data points representing damage/repair locations or other events throughout the geographical area under consideration.

It will be understood that such maps or other visual displays preferably show the density surface of the damage data overlaid or otherwise combined with physical features such as roads and administrative boundaries such as cities or counties, together with wire centers between which underground or other physical plant extends, service areas, or other relevant physical or functional features within the geographical region of interest. Those physical features generally remain fixed or change relatively infrequently, and thus do not require the current geographical information associated with variable events as described herein. The raw data from the database 114 may be classified in various ways, such as by mean and standard deviation, with such classifications appearing on the mapped display as numeric information adjacent the geographic events or areas to which such statistical analyses apply. Because the information available from the database 114 for mapping includes the current and accurate geographic locations of every event for which the one or more portable data terminals 110 have collected information, without delay or error arising from manual collection or entry of the geographical location information relating to those events, mapped representations of those events may be generated on a regular basis or on demand, and with relatively little lag between the latest occurrences of such events and the generation of the maps. This up-to-date availability of mapping or other visual display provides a more useful and effective presentation versus spreadsheets or other tabular listings, which may include all the data but may obscure trends that may emerge from a mapped or other graphical presentation based on that same data.

Although FIG. 1 depicts a single portable data terminal 110 functionally connected to the database 114, it should be apparent that practical applications will utilize several or perhaps many such portable data terminals in connection with performing service or other tasks. For example, a telecommunications service provider may operate a fleet of service vehicles each having onboard a portable data terminal 110, whether mounted on the vehicle or in the form of a notebook computer or other relatively portable computing device. Each such portable data terminal 110, according to disclosed embodiments, captures geographic location information from an associated GPS receiver 112 in response to entering predetermined event activity into the portable data terminal 110. The occurrence of those events, together with geographic location information captured in response to entry of each event, is transferred to the database 114 as discussed above, and it will be understood that the GIS system at the processor 116 may function to aggregate the geographic location information and related data for a number of such events. That aggregated data corresponding to a number of service repairs or other events may then be used to generate maps or other visual displays representing the geographic locations, density, and other factors concerning events of interest occurring within a selected geographic region.

It should also be understood that the foregoing relates only to preferred embodiments of the present invention, and that numerous changes and modifications thereto may be made without departing from the spirit and scope of the following claims.

We claim:

1. A method for obtaining location information relating to at least one task performed at a geographic location within a predetermined geographic region, comprising:
receiving information relating to performance of the task in a computing device at the geographic location; and
in response to receipt of the information in the computing device, obtaining location data corresponding to the geographic location of the computing device and thus corresponding to the geographic location of the task.

2. The method as in claim 1, further comprising:
using the geographic location data obtained by the computing device to produce a map that includes a visual representation corresponding to the task and the geographic location within the predetermined geographic region.

3. The method as in claim 1, wherein the location data comprises global positioning system (GPS) information obtained at the geographic location.

4. The method as in claim 3, wherein the GPS location information is obtained by a GPS receiver incorporated with the computing device.

5. The method as in claim 3, wherein the GPS location information is obtained from a GPS receiver separate from the computing device.

6. The method as in claim 2, further comprising including on the map a representation of other information relating to the task performed at the geographic location of the task and spatially juxtaposed with the visual representation corresponding to the task.

7. A system for representing information relating to at least one task performed at a geographic location within a predetermined geographic region, comprising:
means for receiving information relating to performance of the task in a computing device present at the geographic location; and
means operative, in response to receipt of the information, for obtaining location data corresponding to the geographic location of the computing device and thus corresponding to the geographic location of the task.

8. The system as in claim 7, further comprising:
means for using the geographic location data obtained by the computing device to produce a map that includes a visual representation corresponding to the task and the geographic location within the predetermined geographic region.

9. The system as in claim 7, wherein the means for obtaining location data comprises a GPS receiver at the geographic location.

10. The system as in claim 9, wherein the GPS receiver is incorporated with the computing device.

11. The system as in claim 9, wherein the GPS receiver is separate from the computing device.

12. The method as in claim 8, wherein the means for producing the map is operative to include on the map a representation of other information relating to the task performed at the geographic location of the task and spatially juxtaposed with the visual representation corresponding to the task.

13. A computer-readable medium containing instructions for performing a method for obtaining location information relating to at least one task performed at a geographic location within a predetermined geographic region, the method comprising:
receiving information relating to performance of the task in a computing device at the geographic location; and
in response to receipt of the information in the computing device, obtaining location data corresponding to the geographic location of the computing device and thus corresponding to the geographic location of the task.

14. The computer-readable medium as in claim 13, the method further comprising:
using the geographic location data obtained by the computing device to produce a map that includes a visual representation corresponding to the task and the geographic location within the predetermined geographic region.

15. The computer-readable medium as in claim 13, wherein the location data comprises global positioning system (GPS) information obtained at the geographic location.

16. The computer-readable medium as in claim 15, wherein the GPS location information is obtained by a GPS receiver incorporated with the computing device.

17. The computer-readable medium as in claim 15, wherein the GPS location information is obtained from a GPS receiver separate from the computing device.

18. The computer-readable medium as in claim 14, the method further comprising including on the map a representation of other information relating to the task performed at the geographic location of the task and spatially juxtaposed with the visual representation corresponding to the task.
